(19) United States
(12) Patent Application Publication
(10) Pub. No.: US 2024/0400170 A1
(43) Pub. Date: Dec. 5, 2024

(54) Identification Processing Method And System For Ship-To-Ship Refueling

(71) Applicant: Shanghai Ship & Shipping Research Institute Co., Ltd., Shanghai (CN)

(72) Inventors: Yu ZHOU, Shanghai (CN); Lin ZHU, Shanghai (CN)

(21) Appl. No.: 18/690,847

(22) PCT Filed: Sep. 17, 2021
(86) PCT No.: PCT/CN2021/119103

§ 371 Date: Mar. 11, 2024

(30) Foreign Application Priority Data
Sep. 13, 2021 (CN) 202111069769.5

(51) Int. Cl. B63B 79/10; B63B 27/30; G06Q 50/40

(52) U.S. Cl. CPC B63B 79/10; B63B 27/30; G06Q 50/40

(57) ABSTRACT

The present invention provides an identification processing method and system for ship-to-ship refueling. The method comprises a target ship identification step, a target ship type determination and identification step, a ship speed and AIS reporting time determination step, a ship-to-ship position determination step and a refueling data processing step. Based on massive ship AIS data, a refueling ship and a non-refueling ship are determined by means of a ship type, and in combination with ship speed, AIS reporting time difference determination and a proximity algorithm, a refueling behavior of the ship in a certain period of time can be automatically determined, such that relevant personnel can quickly know the refueling situation of the ship.

### TECHNICAL FIELD

The present invention relates to a technical field of shipping informatization and shipping intelligence, and specifically relates to an identification processing method and system for ship-to-ship refueling based on massive ship AIS data.

### BACKGROUND TECHNIQUE

Automatic Identification System (AIS) is a kind of ship navigation device implemented by wireless communication technology and computer technology etc. AIS uses a ship's globally unique coding system, i.e. MMSI code, as a means of identification. Each ship is given a globally unique MMSI code from the beginning of construction to the dismantling of the ship. With the assistance of the Global Positioning System (GPS), AIS can broadcast ship dynamic information such as ship speed, ship position, course change rate and course, combined with ship static data such as ship name, call sign, draft and dangerous goods information, through Very High Frequency (VHF) channels to ships in nearby waters and shore stations, so that adjacent ships and shore stations can timely grasp the dynamic information of all ships on the nearby sea. AIS data is a collective term for all data sent by a ship every time.

Database PostgreSQL is a free object-relational database management system (ORDBMS) for storing and managing large data volumes. The so-called relational database is a database based on a relational model, which uses mathematical concepts and methods such as set algebra to process the data in the database.

PostGIS is an open source program. It is an extension of the object-relational database PostgreSQL, which provides PostgreSQL with support for storing spatial geographic data, making PostgreSQL a spatial database capable of spatial data management, quantity measurement, and topological analysis.

Geographic coordinates are spherical coordinates that represent the location of ground points in latitude and longitude. The geographic coordinate system has the earth's axis as the polar axis. All planes passing through the Earth's north and south poles are called meridians. Geographic coordinates are the spherical coordinates of the ground points expressed by latitude and longitude.

EPSG: 4326 coordinates, EPSG (The European Petroleum Survey Group) maintains a dataset of spatial reference objects. EPSG: 4326 is a code for WGS84. WGS84 (World Geodetic System 1984) is a coordinate system established for use by GPS Global Positioning System. It is currently the most popular geographic coordinate system. Internationally, each coordinate system is assigned an EPSG code. GPS is based on WGS84, so usually the coordinate data we get is WGS84.

Since the AIS data is massive, and the AIS obtains a location point, and the time of each AIS point does not match, it is impossible to determine whether a refueling ship and a non-refueling ship are approaching. In prior art, ship usually actively reports refueling record. This may result in delays in reporting, forgetting and omitting reports, etc., resulting in failure to monitor ship refueling in time.

### SUMMARY OF THE INVENTION

The present invention is aimed at a problem of failure to timely monitor the ship refueling, etc. This problem is caused by delays in reporting, forgetting to report and omission in the process of existing ships actively reporting refueling records. The present invention provides an identification processing method for ship-to-ship refueling. Based on massive ship AIS data, a refueling ship and a non-refueling ship are determined by means of a ship type, and in combination with ship speed, AIS reporting time difference determination and a proximity algorithm, a refueling behavior of the ship in a certain period of time can be automatically determined, such that relevant personnel can quickly know the refueling situation of the ship. The present invention also relates to an identification processing system for ship-to-ship refueling.

The technical solution of the present invention is as follows:

An identification processing method for ship-to-ship refueling, comprising following steps:
a target ship identification step, which identifies target ships based on MMSI code of massive ship AIS data, and obtains AIS reporting time, position, speed, size, ship type, load and bow direction information of the target ships;
a target ship type determination and identification step, which filters out target ship types according to the ship type and load of the target ships, wherein the target ship types are a refueling ship and a non-refueling ship;
a ship speed and AIS reporting time determination step, which performs ship speed filtering and AIS reporting time filtering, wherein in the filtering process, when obtained speed is less than a preset speed threshold and a time difference between the target ships' AIS reporting time is less than a preset time difference threshold, conditions are met;
a ship-to-ship position determination step, which uses a proximity algorithm to calculate whether the positions of the ships are adjacent based on the position, size and bow direction information obtained for the refueling ship and the non-refueling ship that meet the conditions;
a refueling data processing step, which treats the AIS data as refueling intention data when the positions of the ships are adjacent to each other, and which determines the refueling intention data as refueling data for processing if continuous refueling intention data is detected within a certain time interval.

Preferably, wherein the target ship type determination and identification step, conditions for filtering out the target ship types are:
when a class II ship type corresponds to a refueling ship, or a class III ship type corresponds to a refined oil carrying capacity of less than 10,000 DW, or a class III ship type corresponds to a crude oil/refined oil carrying capacity of less than 10,000 DW, or a class III ship type corresponds to a refined oil/chemical tanker carrying capacity of less than 10,000 DW, the target ship type is identified as the refueling ship;
in addition to above filter conditions for refueling ship, and a class II ship type is a ship type other than push tug boat, tugboat, fishing boat, refueling ship, cruise ship, passenger ship, high-speed passenger ship, passenger and cargo ship, floating warehouse oil, floating warehouse gas, wind power installation, floating crane, the target ship is recognized as the non-refueling ship.

Preferably, wherein the ship speed and AIS reporting time determination step, when the obtained speed is less than the preset speed threshold of 0.2 knots and the time difference between the AIS reporting time of the refueling ship and the AIS reporting time of the non-refueling ship is within the preset time difference threshold of 5 minutes, the conditions are met; and then the ship-to-ship position determination step is performed.

Preferably, wherein the ship-to-ship position determination step, the proximity algorithm employed includes an accurate algorithm; the accurate algorithm calculates overall contour area of the refueling ship and the non-refueling ship according to the AIS position, size and bow direction information, respectively; expand the overall contour area on original area so that an intersection function can be used for the refueling ship and the non-refueling ship to calculate whether the positions of the two ships are adjacent to each other.

Preferably, wherein the ship-to-ship position determination step, the proximity algorithm employed includes an approximate algorithm; based on obtained position, size and bow direction information, the approximate algorithm, along the bow direction, from obtained position of the non-refueling ship, extends forward and backward by a distance, respectively, which is equal to a length of the non-refueling ship, at the same time, the approximate algorithm, in the direction perpendicular to the bow direction, from the obtained position of the non-refueling ship, extends to left and right a distance, respectively, which is equal to total width of the refueling ship and the non-refueling ship, thereby obtaining a rectangular area; the approximate algorithm then sets a peripheral rectangle along longitude and latitude lines based on corner points of the rectangular area; the approximate algorithm obtains four values of maximum longitude, minimum longitude, maximum latitude and minimum latitude based on the peripheral rectangle; the approximate algorithm then determines whether the longitude and latitude of the position of the refueling ship are within the peripheral rectangle; when within the peripheral rectangle, this approximate algorithm identifies the ship-to-ship position as proximity.

Preferably, wherein the refueling data processing step, when the positions of the ships are adjacent to each other, the AIS data is stored as refueling intention data in a database; and recent refueling intention data is retrieved from the database; the refueling intention data for paired refueling ship and non-refueling ship are arranged chronologically; a coherent behavior is identified when continuous refueling intention data is detected at a certain time interval; if a time difference between refueling end time and latest AIS reporting time of the non-refueling ship is within a preset time threshold, a refueling behavior is determined; relevant data is identified as refueling data for processing and stored in the database.

An identification processing system for ship-to-ship refueling, comprising a target ship identification module, a target ship type determination and identification module, a ship speed and AIS reporting time determination module, a ship-to-ship position determination module and a refueling data processing module connected sequentially;
the target ship identification module identifies target ships based on MMSI code of massive ship AIS data, and obtains AIS reporting time, position, speed, size, ship type, load and bow direction information of the target ships;
the target ship type determination and identification module filters out target ship types according to the ship type and load of the target ships, wherein the target ship types are a refueling ship and a non-refueling ship;
the ship speed and AIS reporting time determination module performs ship speed filtering and AIS reporting time filtering, wherein in the filtering process, when obtained speed is less than a preset speed threshold and a time difference between the target ships' AIS reporting time is less than a preset time difference threshold, conditions are met;
the ship-to-ship position determination module uses a proximity algorithm to calculate whether the positions of the ships are adjacent based on the position, size and bow direction information obtained for the refueling ship and non-refueling ship that meet the conditions;
the refueling data processing module treats the AIS data as refueling intention data when the positions of the ships are adjacent to each other, and determines the refueling intention data as refueling data for processing if continuous refueling intention data is detected within a certain time interval.

Preferably, wherein the ship speed and AIS reporting time determination module, when the obtained speed is less than the preset speed threshold 0.2 knots and the time difference between the AIS reporting time of the refueling ship and the AIS reporting time of the non-refueling ship is within the preset time difference threshold of 5 minutes, the conditions are met; and then the process is taken over by the ship-to-ship position determination module.

Preferably, wherein the ship-to-ship position determination module, the proximity algorithm employed includes an accurate algorithm; the accurate algorithm calculates overall contour area of the refueling ship and the non-refueling ship according to the AIS position, size and bow direction information, respectively; expand the overall contour area on original area so that an intersection function can be used for the refueling ship and the non-refueling ship to calculate whether the positions of the two ships are adjacent to each other.

Preferably, wherein the ship-to-ship position determination module, the proximity algorithm employed includes an approximate algorithm; based on obtained position, size and bow direction information, the approximate algorithm, along the bow direction, from obtained position of the non-refueling ship, extends forward and backward by a distance, respectively, which is equal to a length of the non-refueling ship, at the same time, the approximate algorithm, in the direction perpendicular to the bow direction, from the obtained position of the non-refueling ship, extends to left and right a distance, respectively, which is equal to total width of the refueling ship and the non-refueling ship, thereby obtaining a rectangular area; the approximate algorithm then sets a peripheral rectangle along longitude and latitude lines based on corner points of the rectangular area; the approximate algorithm obtains four values of maximum longitude, minimum longitude, maximum latitude and minimum latitude based on the peripheral rectangle; the approximate algorithm then determines whether the longitude and latitude of the position of the refueling ship are within the peripheral rectangle; when within the peripheral rectangle, this approximate algorithm identifies the ship-to-ship position as proximity.

The beneficial effects of the present invention are as follows:

The present invention provides an identification processing method for ship-to-ship refueling. Based on massive ship AIS data, this method performs in turn, target ship type determination and identification, ship speed determination and identification, AIS reporting time difference determination and identification, ship-to-ship position determination identification, and refueling data processing. This method is able to determine whether a refueling ship or a non-refueling ship, and in combination with the time recognition algorithm, proximity algorithm and monitoring technology, a refueling behavior of the ship in a certain period of time can be automatically determined, so that relevant personnel can quickly know the refueling situation of the ship. Therefore, the present invention can avoid the problems of failure to monitor the ship refueling in time due to the delay in reporting, forgetting to report and omission when manually reporting the refueling records in the prior art, so that the ship-to-ship refueling is timely and efficient, and shipping efficiency is improved.

The present invention also relates to an identification processing system for ship-to-ship refueling. The system corresponds to the identification processing method for ship-to-ship refueling described above, and can be understood as a system that implements the identification processing method for ship-to-ship refueling described above. The system includes a target ship identification module, a target ship type determination and identification module, a ship speed and AIS reporting time determination module, a ship-to-ship position determination module and a refueling data processing module connected sequentially. These modules, cooperatively, based on massive AIS data, automatically obtain and identify refueling through relevant data reported by AIS, and identify the refueling ship and non-refueling ship that are adjacent to each other for a certain period of time, so that refueling situation can be responded to in a more timely manner.

### DESCRIPTION OF THE DRAWINGS

FIG. 1 is a flowchart of the identification processing method for ship-to-ship refueling in accordance with the present invention.

FIG. 2 is a schematic of ship-to-ship position determination.

### DETAILED DESCRIPTION OF THE PREFERRED EMBODIMENTS

The present invention will be described below with reference to accompanying drawings.

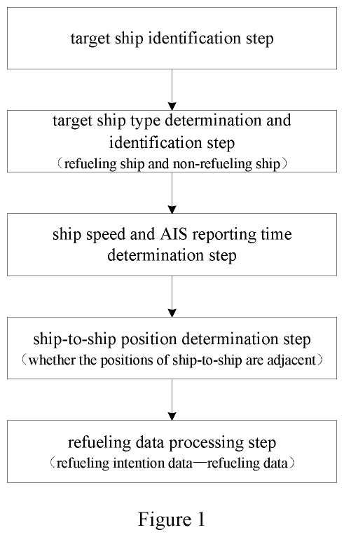

The present invention relates to an identification processing method for ship-to-ship refueling, the flowchart of which is shown in FIG. 1, comprising:

(1) A target ship identification step, which identifies target ships based on MMSI code of massive ship AIS data, and obtains the target ships' AIS reporting time, position, speed, size, ship type, load and bow direction information.

Ship AIS data is a record sent by each ship at regular intervals (usually in the order of seconds or minutes), and the data that needs to be processed each time is equivalent to each ship having one record. Firstly, the target ships are identified according to basic information (ship type, size, etc.) obtained by MMSI, and the AIS reporting time, position, speed, load, bow direction, length, and width of the target ships are obtained.

(2) A target ship type determination and identification step, which filters out target ship types according to the ship type and load of the target ship, wherein the target ship types are a refueling ship and a non-refueling ship. Preferably, conditions for filtering out the target ship types are:

The refueling ship (ships that actively refuel other ships; relationship between following conditions is OR; if a single condition is met, the condition is met; DW means deadweight ton):
The class II ship type corresponds a refueling ship;
The class III ship type corresponds to a refined oil carrying capacity of 10,000DW or less;
The class III ship type corresponds to a crude oil/refined oil carrying capacity of 10,000DW or less;
The class III ship type corresponds to a refined oil/chemical tanker carrying capacity of 10,000DW or less;
Main body of shipping company is China Marine Bunker Co., Ltd.;
Main body of shipping company is China Shipping & SINOPEC Suppliers Co., Ltd.

The non-refueling ship (ships being refueled by refueling ships; relationship between following conditions is AND; all of these conditions need to be met at the same time):
The class II ship type does not correspond to push tugs, tugs, fishing boats, and tankers;
The class II ship type does not correspond to cruise ships, passenger ships, high-speed passenger ships, passenger and cargo ships;
The class II ship type does not correspond to floating warehouse oil, floating warehouse gas, wind power installation, floating crane;
The class III ship type does not correspond to the refined oil carrying capacity of 10,000DW or less, the crude oil/refined oil carrying capacity of 10,000DW or less, or the refined oil/chemical tanker carrying capacity of 10,000DW or less;
Main body of shipping company is not China Marine Bunker Co., Ltd. or China Shipping & SINOPEC Suppliers Co., Ltd.

(3) A ship speed and AIS reporting time determination step, which performs ship speed filtering and AIS reporting time filtering, wherein in the filtering process, when obtained speed is less than a preset speed threshold and a time difference between the target ships' AIS reporting time is less than a preset time difference threshold, conditions are met.

During refueling process, the ships are at anchor and in a relatively static state. Based on the ship information obtained in the first step, it is determined that such a refueling ship and non-refueling ship meet the conditions: their speed is less than 0.2 knots (knots per hour, other speed thresholds can also be set) and the time difference between their AIS reporting time is within a certain time (such as 5 minutes, other time difference thresholds can also be set).

(4) A ship-to-ship position determination step, which uses a proximity algorithm to calculate whether the positions of the ships are adjacent based on the position, size and bow direction information obtained for the refueling ship and non-refueling ship that meet the conditions. If the positions of the refueling ship and non-refueling ship are in close proximity, this data is inserted into the database as intention data to identify refueling. There are two kinds of refueling ship and non-refueling ship proximity algorithms, one is an accurate algorithm and the other is an approximate algorithm.

The accurate algorithm, that is relatively accurate algorithm, is characterized by slow recognition speed, but relatively accurate calculation positions:

Since the AIS data reports a specific POINT, overall contour area (a rectangular area) of the refueling ship and the non-refueling ship is calculated according to the position reported by AIS, the specific position of AIS installed on the ship, distances between the AIS and the bow, stern, left edge, right edge of the ship, and bow direction of the ship.

Depending on parameter setting of proximity range (e.g. 10 meters), the rectangular area of the non-refueling is extended over original area. An intersection function ST_Intersects of PostGIS is then used for the non-refueling ship and refueling ship. If two areas intersect, it is recognized that the two ship's positions are proximity.

The approximate algorithm is characterized by fast recognition speed:

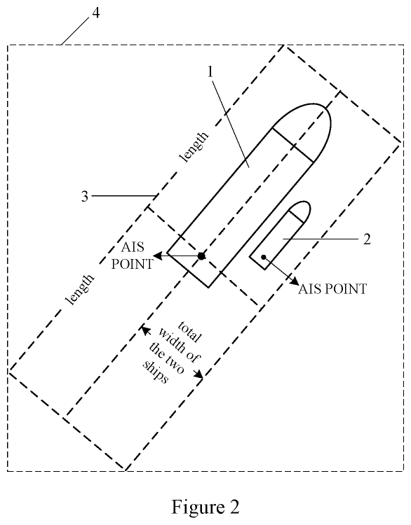

The refueling ship is relatively small compared to the non-refueling ship. As shown in FIG. 2, a rectangular area 3 is obtained by directly extending along the bow direction, from reported position of the non-refueling ship 1, forward and backward by a distance, respectively, which is equal to a length of the non-refueling ship; and extending, at the same time, in the direction perpendicular to the bow direction, from the reported position of the non-refueling ship, to the left and right a distance, respectively, which is equal to total width of two ships (width of the refueling ship 2+ width of the non-refueling ship 1). And a peripheral rectangle 4 containing the rectangular area 3 is obtained (along longitude and latitude lines) based on four corner points of the rectangular area 3. Four values of maximum longitude, minimum longitude, maximum latitude and minimum latitude are obtained based on the peripheral rectangle 4.

Then the longitude and latitude of reported position of the refueling ship are compared with longitude range (the range between the minimum longitude and the maximum longitude) and latitude range (the range between the minimum latitude and the maximum latitude) obtained above, respectively, to determine whether the longitude and latitude of the reported position of the refueling ship are within these ranges. If within these ranges, the position between the ship-to-ship is recognized as proximity.

Length of the earth's meridian (connection from south pole to north pole) is 39940.67 km, and one latitude corresponds to 111 km. Length of the equatorial circle is 40075.36 km, and one longitude corresponds to 111 km. Length corresponding to one longitude on latitude A is 111*cosA km. Meanings of calculated parameters:

Lat represents latitude, lon represents longitude, len represents the length of the ship, hdg represents the bow of the ship, win represents the total width of the two ships, PI is pi, and abs represents absolute value.

Calculation of reported position at east longitude and north latitude coordinate system (positive east longitude, negative west longitude, positive north latitude, negative south latitude):

$$Maximum longitude : lon + abs ( len * sin ( hdg * PI / 180 ) + win * cos ( hdg * PI / 180 ) ) / ( 111000 * cos ( lat * PI / 180 ) )$$

$$Minimum longitude : lon - abs ( len * sin ( hdg * PI / 180 ) + win * cos ( hdg * PI / 180 ) ) / ( 111000 * cos ( lat * PI / 180 ) )$$

$$Maximum lagitude : lat + abs ( len * cos ( hdg * PI / 180 ) + win * sin ( hdg * PI / 180 ) ) / 111000.$$

$$Minimum lagitude : lat - abs ( len * cos ( hdg * PI / 180 ) + win * sin ( hdg * PI / 180 ) ) / 111000.$$

(5) A refueling data processing step, which treats the AIS data as refueling intention data when the positions of the ships are adjacent to each other, and which determines the refueling intention data as refueling data for processing if continuous refueling intention data is detected within a certain time interval.

When the positions of the ships are adjacent to each other, the AIS data is stored in a database as refueling intention data. Duration of refueling of a ship is generally in the range of a few hours to a few days, and refueled ship will not be refueled again for a short period of time (e.g. 1 day). Therefore, recent refueling intention data (identified in step 2 and stored in the database) can be retrieved from the database, such as the refueling intention data of the last 10 days (the settings can be changed, including a complete refueling record). Data for paired refueling ship and non-refueling ship are arranged chronologically, if a time interval between two adjacent data is less than 1 day (changeable setting), the two adjacent data are identified as a coherent behavior. If the duration of all data identified as a coherent behavior is more than 2 hours (changeable configuration, less than this time may be other behaviors), and time difference between refueling end time (the last end time of continuous behavior) and time reported by latest AIS of the non-refueling ship is within 10 minutes (changeable configuration), the coherent behavior is considered to be a refueling behavior, and the refueling data (refueling ship's MMSI, non-refueling ship's MMSI, refueling start time, refueling end time) is stored in the database.

When storing above refueling data in the database, it is necessary to match the refueling ship's MMSI, non-refueling ship's MMSI, and the refueling start time with existing data in the database. If there is a piece of existing data in the database that matches the refueling data to be stored, the refueling end time of the existing data in the database is changed to a new refueling end time of the refueling data; Otherwise, the refueling data is inserted into the database as a new record. When the end time of refueling is no longer changed, a complete refueling record is identified. If subsequent AIS is lost or not received for other reasons, previous data lasting more than 2 hours will be regarded as a complete refueling record.

The present invention will be described below by a specific example.

Assume that a new AIS data is received, as shown in Table I below:

TABLE 1

| SHIP MMSI | 100000001 | 100000002 |
|---|---|---|
| SHIP TYPE | container | liquid bulk cargo |
| CLASS II SHIP TYPE | full-container | refueling ship |
| DW (ton) | 41553 | 3150 |
| SHIP LENGTH (m) | 202.8 | 88 |
| SHIP WIDTH (m) | 30.6 | 13.5 |
| AIS TIME | 2021 Jul. 14 | 2021 Jul. 14 |
| | 17:07:47 | 17:09:18 |
| LONGITUDE (EPSG:4326 | 119.53435 | 119.53412 |
| COORDINATE) | | |
| LATITUDE (EPSG:4326 | 35.356342 | 35.35636 |
| COORDINATE) | | |
| BOW DIRECTION (degree) | 359 | 2 |
| SPEED (knot) | 0.049472 | 0.010601 |

First, the target ship types are filtered out, i.e. refueling ship and non-refueling ship:

Because the ship type of the ship with ship MMSI 100000001 is container, and its class II ship type is full-container, the ship is identified as the non-refueling ship.

Because the ship type of the ship with ship MMSI 100000002 is liquid bulk cargo, and its class II ship type is refueling ship, the ship is identified as the refueling ship.

After the target ships are identified, other conditions are filtered: Speed: Both ships have speeds of less than 0.2 knots.

AIS Time Difference: The time difference between 2021 Jul. 14 17:09:18 and 2021 Jul. 14 17:07:47 is 1 minute and 31 seconds, less than 5 minutes, which meets the conditions.

Considering the non-refueling ship as a reference point, using the approximate algorithm, extent of the rectangular area is calculated:

$$Maximum longitude : lon + abs ( len * sin ( hdg * PI / 180 ) + win * cos ( hdg * PI / 180 ) ) / ( 111000 * cos ( lat * PI / 180 ) ) = 119.53435 + abs ( 202.8 * sin ( 359 * PI / 180 ) + ( 30. 6 + 13.5 ) * cos ( 359 * PI / 180 ) ) / ( 111000 * cos ( 35.356342 * PI / 180 ) ) = 119.5348$$

$$Minimum longitude : lon - abs ( len * sin ( hdg * PI / 180 ) + win * cos ( hdg * PI / 180 ) ) / ( 111000 * cos ( lat * PI / 180 ) ) = 11 \; 9.53 \; 435 - abs ( 202.8 * sin ( 359 * PI / 180 ) + ( 30. 6 + 1 \; 35 ) * cos ( 359 * PI / 180 ) ) / ( 111000 * cos ( 35.356342 * PI / 180 ) ) = 11 \; 9.5 \; 3390$$

$$Maximum lagitude : lat + abs ( len * cos ( hdg * PI / 180 ) + win * sin ( hdg * PI / 180 ) ) / 111000. = 35.356342 + abs ( 202.8 * cos ( 359 * PI / 180 ) + ( 30. 6 + 13.5 ) * sin ( 359 * PI / 180 ) ) / 111000. = 35.358162$$

$$Minimum lagitude : lat - abs ( len * cos ( hdg * PI / 180 ) + win * sin ( hdg * PI / 180 ) ) / 111000. = 35.356342 - abs ( 202.8 * cos ( 359 * PI / 180 ) + ( 30. 6 + 13.5 ) * sin ( 359 * PI / 180 ) ) / 111000. = 35.35452$$

It is determined whether the latitude and longitude of the refueling ship are within aforementioned rectangular area:
Longitude determination: 119.53390<119.53412<119.53480
Latitude determination: 35.35452<35.35636<35.358162

The conditions are met, and the two data are combined into a refueling intention data and stored in the database.

Since only one intention data is saved above, there is no duration available for determination at this time, and it is not currently processed as fueling data. If a total of 12 pieces of data are received continuously every 10 minutes in next 2 hours, that is, the data from 2021 Jul. 14 17:07:47 to 2021 Jul. 14 19:07:47 are obtained at this time, above two ships have been in an adjacent state, at only then are they stored as a piece of refueling data in the database:

The ship with MMSI 100000001 is refueled at longitude 119.53435 and latitude 35.356342 by the ship with MMSI 100000002 for 2 hours from 2021 Jul. 14 17:07:47 to 2021 Jul. 14 19:07:47.

If data of these two ships are received consecutively after 2021 Jul. 14 19:07:47, the refueling end time of above refueling data is changed at this time. If another data is received at 2021 Jul. 14 20:07:47, refueling time at this time is 2021 Jul. 14 17:07:47 to 2021 Jul. 14 20:07:47, for 3 hours. In the next 1 day, if the refueling intention data of above two ships is not received again, the refueling data at this time is a complete refueling data.

The present invention also relates to an identification processing system for ship-to-ship refueling. The system corresponds to the identification processing method for ship-to-ship refueling described above, and can be understood as a system that implements the identification processing method for ship-to-ship refueling described above. The system includes a target ship identification module, a target ship type determination and identification module, a ship speed and AIS reporting time determination module, a ship-to-ship position determination module and a refueling data processing module connected sequentially. These modules, cooperatively, based on massive AIS data, automatically obtain and identify refueling through relevant data reported by AIS, and identify the refueling ship and non-refueling ship that are adjacent to each other for a certain period of time, so that the refueling situation can be responded to in a more timely manner.

Wherein, the target ship identification module identifies target ships based on MMSI code of massive ship AIS data, and obtains AIS reporting time, position, speed, size, ship type, load and bow direction information of the target ships. The target ship type determination and identification module filters out target ship types according to the ship type and load of the target ships, wherein the target ship types are a refueling ship and a non-refueling ship. The ship speed and AIS reporting time determination module performs ship speed filtering and AIS reporting time filtering, wherein in the filtering process, when obtained speed is less than a preset speed threshold and a time difference between the target ships' AIS reporting time is less than a preset time difference threshold, the target ships meets the conditions. The ship-to-ship position determination module uses a proximity algorithm to calculate whether the positions of the ships are adjacent based on the position, size and bow direction information obtained for the refueling ship and non-refueling ship that meet the conditions. The refueling data processing module treats the AIS data as refueling intention data when the positions of the ships are adjacent to each other, and determines the refueling intention data as refueling data for processing if continuous refueling intention data is detected within a certain time interval.

Further, in the ship speed and AIS reporting time determination module, when the obtained speed is less than the preset speed threshold 0.2 knots and the time difference between the AIS reporting time of the refueling ship and the AIS reporting time of the non-refueling ship is within the preset time difference threshold of 5 minutes, the conditions are met; and then the process is taken over by the ship-to-ship position determination module.

Further, in the ship-to-ship position determination module, the proximity algorithm employed includes an accurate algorithm; the accurate algorithm calculates overall contour area of the refueling ship and the non-refueling ship according to the AIS position, size and bow direction information, respectively; expand the overall contour area on original area so that an intersection function can be used for the refueling ship and the non-refueling ship to calculate whether the positions of the two ships are adjacent to each other.

Or, further, in the ship-to-ship position determination module, the proximity algorithm employed includes an approximate algorithm; based on the obtained position, size and bow direction information, the approximate algorithm, along the bow direction, from obtained position of the non-refueling ship, extends forward and backward by a distance, respectively, which is equal to a length of the non-refueling ship, at the same time, the approximate algorithm, in the direction perpendicular to the bow direction, from the obtained position of the non-refueling ship, extends to left and right a distance, respectively, which is equal to total width of the refueling ship and the non-refueling ship, thereby obtaining a rectangular area; the approximate algorithm then sets a peripheral rectangle along longitude and latitude lines based on corner points of the rectangular area; the approximate algorithm obtains four values of maximum longitude, minimum longitude, maximum latitude and minimum latitude based on the peripheral rectangle; the approximate algorithm then determines whether the longitude and latitude of the position of the refueling ship are within the peripheral rectangle; when within the peripheral rectangle, this approximate algorithm identifies the ship-to-ship position as proximity.

It should be noted that above-described specific embodiments may enable those skilled in the art more fully understand the present invention rather than limit the present invention in any way. Therefore, although the present specification has been described in detail with reference to the accompanying drawings and embodiments, it should be understood by those skilled in the art that the invention can still be modified or equivalently replaced. In short, all technical solutions and improvements that do not deviate from spirit and scope of the present invention shall all be covered by protection scope of the present invention.

1.-10. (canceled)

11. An identification processing method for ship-to-ship refueling, comprising the following steps:
a target ship identification step, which identifies target ships based on MMSI code of massive ship AIS data, and obtains AIS reporting time, position, speed, size, ship type, load and bow direction information of the target ships;
a target ship type determination and identification step, which filters out target ship types according to the ship type and load of the target ships, wherein the target ship types are a refueling ship and a non-refueling ship;
a ship speed and AIS reporting time determination step, which performs ship speed filtering and AIS reporting time filtering, wherein in the filtering process, when obtained speed is less than a preset speed threshold and a time difference between the target ships' AIS reporting time is less than a preset time difference threshold, conditions are met;
a ship-to-ship position determination step, which uses a proximity algorithm to calculate whether the positions of the ships are adjacent based on the position, size and bow direction information obtained for the refueling ship and the non-refueling ship that meet the conditions; and
a refueling data processing step, which treats the AIS data as refueling intention data when the positions of the ships are adjacent to each other, and which determines the refueling intention data as refueling data for processing if continuous refueling intention data is detected within a certain time interval.

12. The identification processing method for ship-to-ship refueling according to claim 11, wherein the target ship type determination and identification step, conditions for filtering out the target ship types are:
when a class II ship type corresponds to a refueling ship, or a class III ship type corresponds to a refined oil carrying capacity of less than 10,000 DW, or a class III ship type corresponds to a crude oil/refined oil carrying capacity of less than 10,000 DW, or a class III ship type corresponds to a refined oil/chemical tanker carrying capacity of less than 10,000 DW, the target ship type is identified as the refueling ship; and
in addition to above filter conditions for refueling ship, and a class II ship type is a ship type other than push tug boat, tugboat, fishing boat, refueling ship, cruise ship, passenger ship, high-speed passenger ship, passenger and cargo ship, floating warehouse oil, floating warehouse gas, wind power installation, floating crane, the target ship is recognized as the non-refueling ship.

13. The identification processing method for ship-to-ship refueling according to claim 12, wherein the ship-to-ship position determination step, the proximity algorithm employed includes an accurate algorithm; the accurate algorithm calculates overall contour area of the refueling ship and the non-refueling ship according to the AIS position, size and bow direction information, respectively; expand the overall contour area on original area so that an intersection function can be used for the refueling ship and the non-refueling ship to calculate whether the positions of the two ships are adjacent to each other.

14. The identification processing method for ship-to-ship refueling according to claim 12, wherein the ship-to-ship position determination step, the proximity algorithm employed includes an approximate algorithm; based on obtained position, size and bow direction information, the approximate algorithm, along the bow direction, from obtained position of the non-refueling ship, extends forward and backward by a distance, respectively, which is equal to a length of the non-refueling ship, at the same time, the approximate algorithm, in the direction perpendicular to the bow direction, from the obtained position of the non-refueling ship, extends to left and right a distance, respectively, which is equal to total width of the refueling ship and the non-refueling ship, thereby obtaining a rectangular area; the approximate algorithm then sets a peripheral rectangle along longitude and latitude lines based on corner points of the rectangular area; the approximate algorithm obtains four values of maximum longitude, minimum longitude, maximum latitude and minimum latitude based on the peripheral rectangle; the approximate algorithm then determines whether the longitude and latitude of the position of the refueling ship are within the peripheral rectangle; when within the peripheral rectangle, this approximate algorithm identifies the ship-to-ship position as proximity.

15. The identification processing method for ship-to-ship refueling according to claim 11, wherein the ship speed and AIS reporting time determination step, when the obtained speed is less than the preset speed threshold of 0.2 knots and the time difference between the AIS reporting time of the refueling ship and the AIS reporting time of the non-refueling ship is within the preset time difference threshold of 5 minutes, the conditions are met; and then the ship-to-ship position determination step is performed.

16. The identification processing method for ship-to-ship refueling according to claim 15, wherein the ship-to-ship position determination step, the proximity algorithm employed includes an accurate algorithm; the accurate algorithm calculates overall contour area of the refueling ship and the non-refueling ship according to the AIS position, size and bow direction information, respectively; expand the overall contour area on original area so that an intersection function can be used for the refueling ship and the non-refueling ship to calculate whether the positions of the two ships are adjacent to each other.

17. The identification processing method for ship-to-ship refueling according to claim 15, wherein the ship-to-ship position determination step, the proximity algorithm employed includes an approximate algorithm; based on obtained position, size and bow direction information, the approximate algorithm, along the bow direction, from obtained position of the non-refueling ship, extends forward and backward by a distance, respectively, which is equal to a length of the non-refueling ship, at the same time, the approximate algorithm, in the direction perpendicular to the bow direction, from the obtained position of the non-refueling ship, extends to left and right a distance, respectively, which is equal to total width of the refueling ship and the non-refueling ship, thereby obtaining a rectangular area; the approximate algorithm then sets a peripheral rectangle along longitude and latitude lines based on corner points of the rectangular area; the approximate algorithm obtains four values of maximum longitude, minimum longitude, maximum latitude and minimum latitude based on the peripheral rectangle; the approximate algorithm then determines whether the longitude and latitude of the position of the refueling ship are within the peripheral rectangle; when within the peripheral rectangle, this approximate algorithm identifies the ship-to-ship position as proximity.

18. The identification processing method for ship-to-ship refueling according to claim 11, wherein the ship-to-ship position determination step, the proximity algorithm employed includes an accurate algorithm; the accurate algorithm calculates overall contour area of the refueling ship and the non-refueling ship according to the AIS position, size and bow direction information, respectively; expand the overall contour area on original area so that an intersection function can be used for the refueling ship and the non-refueling ship to calculate whether the positions of the two ships are adjacent to each other.

19. The identification processing method for ship-to-ship refueling according to claim 11, wherein the ship-to-ship position determination step, the proximity algorithm employed includes an approximate algorithm; based on obtained position, size and bow direction information, the approximate algorithm, along the bow direction, from obtained position of the non-refueling ship, extends forward and backward by a distance, respectively, which is equal to a length of the non-refueling ship, at the same time, the approximate algorithm, in the direction perpendicular to the bow direction, from the obtained position of the non-refueling ship, extends to left and right a distance, respectively, which is equal to total width of the refueling ship and the non-refueling ship, thereby obtaining a rectangular area; the approximate algorithm then sets a peripheral rectangle along longitude and latitude lines based on corner points of the rectangular area; the approximate algorithm obtains four values of maximum longitude, minimum longitude, maximum latitude and minimum latitude based on the peripheral rectangle; the approximate algorithm then determines whether the longitude and latitude of the position of the refueling ship are within the peripheral rectangle; when within the peripheral rectangle, this approximate algorithm identifies the ship-to-ship position as proximity.

20. The identification processing method for ship-to-ship refueling according to claim 11, wherein the refueling data processing step, when the positions of the ships are adjacent to each other, the AIS data is stored as refueling intention data in a database; and recent refueling intention data is retrieved from the database; the refueling intention data for paired refueling ship and non-refueling ship are arranged chronologically; a coherent behavior is identified when continuous refueling intention data is detected at a certain time interval; if a time difference between refueling end time and latest AIS reporting time of the non-refueling ship is within a preset time threshold, a refueling behavior is determined; relevant data is identified as refueling data for processing and stored in the database.

21. An identification processing system for ship-to-ship refueling, comprising a target ship identification module, a target ship type determination and identification module, a ship speed and AIS reporting time determination module, a ship-to-ship position determination module, and a refueling data processing module connected sequentially;
the target ship identification module identifies target ships based on MMSI code of massive ship AIS data, and obtains AIS reporting time, position, speed, size, ship type, load and bow direction information of the target ships;
the target ship type determination and identification module filters out target ship types according to the ship type and load of the target ships, wherein the target ship types are a refueling ship and a non-refueling ship;
the ship speed and AIS reporting time determination module performs ship speed filtering and AIS reporting time filtering, wherein in the filtering process, when obtained speed is less than a preset speed threshold and a time difference between the target ships' AIS reporting time is less than a preset time difference threshold, conditions are met;
the ship-to-ship position determination module uses a proximity algorithm to calculate whether the positions of the ships are adjacent based on the position, size and bow direction information obtained for the refueling ship and non-refueling ship that meet the conditions; and
the refueling data processing module treats the AIS data as refueling intention data when the positions of the ships are adjacent to each other, and determines the refueling intention data as refueling data for processing if continuous refueling intention data is detected within a certain time interval.

22. The identification processing system for ship-to-ship refueling according to claim 21, wherein the ship speed and AIS reporting time determination module, when the obtained speed is less than the preset speed threshold 0.2 knots and the time difference between the AIS reporting time of the refueling ship and the AIS reporting time of the non-refueling ship is within the preset time difference threshold of 5 minutes, the conditions are met; and then a process is taken over by the ship-to-ship position determination module.

23. The identification processing system for ship-to-ship refueling according to claim 22, wherein the ship-to-ship position determination module, the proximity algorithm employed includes an accurate algorithm; the accurate algorithm calculates overall contour area of the refueling ship and the non-refueling ship according to the AIS position, size and bow direction information, respectively; expand the overall contour area on original area so that an intersection function can be used for the refueling ship and the non-refueling ship to calculate whether the positions of the two ships are adjacent to each other.

24. The identification processing system for ship-to-ship refueling according to claim 22, wherein the ship-to-ship position determination module, the proximity algorithm employed includes an approximate algorithm; based on obtained position, size and bow direction information, the approximate algorithm, along the bow direction, from obtained position of the non-refueling ship, extends forward and backward by a distance, respectively, which is equal to a length of the non-refueling ship, at the same time, the approximate algorithm, in the direction perpendicular to the bow direction, from the obtained position of the non-refueling ship, extends to left and right a distance, respectively, which is equal to total width of the refueling ship and the non-refueling ship, thereby obtaining a rectangular area; the approximate algorithm then sets a peripheral rectangle along longitude and latitude lines based on corner points of the rectangular area; the approximate algorithm obtains four values of maximum longitude, minimum longitude, maximum latitude and minimum latitude based on the peripheral rectangle; the approximate algorithm then determines whether the longitude and latitude of the position of the refueling ship are within the peripheral rectangle; when within the peripheral rectangle, this approximate algorithm identifies the ship-to-ship position as proximity.

25. The identification processing system for ship-to-ship refueling according to claim 21, wherein the ship-to-ship position determination module, the proximity algorithm employed includes an accurate algorithm; the accurate algorithm calculates overall contour area of the refueling ship and the non-refueling ship according to the AIS position, size and bow direction information, respectively; expand the overall contour area on original area so that an intersection function can be used for the refueling ship and the non-refueling ship to calculate whether the positions of the two ships are adjacent to each other.

26. The identification processing system for ship-to-ship refueling according to claim 21, wherein the ship-to-ship position determination module, the proximity algorithm employed includes an approximate algorithm; based on obtained position, size and bow direction information, the approximate algorithm, along the bow direction, from obtained position of the non-refueling ship, extends forward and backward by a distance, respectively, which is equal to a length of the non-refueling ship, at the same time, the approximate algorithm, in the direction perpendicular to the bow direction, from the obtained position of the non-refueling ship, extends to left and right a distance, respectively, which is equal to total width of the refueling ship and the non-refueling ship, thereby obtaining a rectangular area; the approximate algorithm then sets a peripheral rectangle along longitude and latitude lines based on corner points of the rectangular area; the approximate algorithm obtains four values of maximum longitude, minimum longitude, maximum latitude and minimum latitude based on the peripheral rectangle; the approximate algorithm then determines whether the longitude and latitude of the position of the refueling ship are within the peripheral rectangle; when within the peripheral rectangle, this approximate algorithm identifies the ship-to-ship position as proximity.
